(19) United States
(12) Patent Application Publication
(10) Pub. No.: US 2024/0400829 A1
(43) Pub. Date: Dec. 5, 2024

(54) MOISTURE CURABLE COMPOSITIONS

(71) Applicant: DOW SILICONES CORPORATION, Midland, MI (US)

(72) Inventors: Christine MARCHAND, Midland, MI (US); Dongchan AHN, Midland, MI (US); Tommy DETEMMERMAN, Seneffe (BE); Thierry DESSILLY, Seneffe (BE); Stephen HLINKA, II, Midland, MI (US)

(21) Appl. No.: 18/695,042

(22) PCT Filed: Sep. 26, 2022
(86) PCT No.: PCT/US2022/044687

§ 371 Date: Mar. 25, 2024

Related U.S. Application Data
(60) Provisional application No. 63/250,248, filed on Sep. 30, 2021.

(51) Int. Cl. C08L 83/04; C08K 3/04; C08K 3/36; C09D 183/04

(52) U.S. Cl. CPC C08L 83/04; C08K 3/04; C08K 3/36; C09D 183/04

(57) ABSTRACT

A two-part moisture cure organopolysiloxane composition comprising a base part and a catalyst package part is provided. The catalyst package part, despite comprising amino silane(s), alkoxy silane(s), and tin catalyst(s) and optionally reinforcing filler(s) and/or extending filler(s) in a carrier fluid, undergoes minimal phase separation during storage. This is achieved by utilizing silicon-free linear or branched polyethers comprising repeating units having the average formula (—CₙH₂ₙ—O—)_{y} wherein n is an integer from 3 to 6 inclusive and y is at least four, comprising one or more —OH terminal groups, —OR¹⁰ terminal groups or —OH and —OR¹⁰ terminal groups where R¹⁰ is an optionally functionalised hydrocarbon group having from 1 to 12 carbons; as the carrier fluid, enabling the catalyst package part to function as a shelf stable continuous phase.

There is provided a two-part moisture cure organopolysiloxane composition comprising a base part and a catalyst package wherein the catalyst package, despite comprising amino silane(s), alkoxy silane(s), tin catalyst(s) and optionally reinforcing filler(s) and/or extending filler(s) in a carrier fluid, undergoes minimal phase separation during storage, by utilizing a silicon-free polyether as the carrier fluid, enabling the catalyst package to be stored and function as a shelf stable continuous phase.

Condensation curable organosiloxane compositions, which cure to elastomeric solids, are well known. Typically, such compositions are obtained by mixing a polydiorganosiloxane having two or more hydroxy groups and/or hydrolysable groups per molecule, with e.g., a silane cross-linking agent which is reactive with the polydiorganosiloxane, for example an acetoxy silane, an oximosilane, an aminosilane or an alkoxysilane in the presence of a suitable catalyst. Such condensation curable organopolysiloxane compositions are generally provided in either one-part or multiple-part, e.g., two-part compositions.

Conventional one-part compositions are usually cured utilizing titanate or zirconate type catalysts via a skin or diffusion cure mechanism by initially forming a cured skin at the composition/air interface subsequent to the sealant/encapsulant being applied on to a substrate surface. This is then followed by a gradual thickening of the cured skin over time from the cured skin into the bulk of the composition with the cure speed dependent on the speed of diffusion of moisture from the sealant/encapsulant interface with air to the inside (or bulk) of the composition, and the diffusion of condensation reaction by-product/effluent from the bulk of the composition out through the cured skin. These formulations are typically applied onto a substrate or the like in a layer that is thinner than 15 mm.

In contrast, conventional two-part organopolysiloxane compositions comprise:
a first part (base) that contains silanol-terminated diorganopolysiloxane and a reinforcing filler e.g., precipitated calcium carbonate; and
a second part (catalyst or cure package) containing an alkyl-terminated diorganopolysiloxane, tin based catalyst, cross-linker and aminosilane, e.g., a primary aminosilane.

The properties of individual parts of said multi-part compositions are generally not affected by atmospheric moisture. Once mixed together the resulting mixture possesses excellent deep curability and enables substantially uniform curing throughout the entire body of the sealing material. This is because curing proceeds via a bulk cure mechanism wherein the composition will cure simultaneously throughout the material bulk thereby providing a sealant and adhesive materials able to cure in comparatively thicker layers than the above one-part compositions to provide an elastomeric body of greater than 15 mm in depth. It is generally acknowledged that the cure speed of two-part moisture cure organopolysiloxane compositions, such as silicone adhesive/sealant compositions, as described above provide excellent deep curability and substantially uniform curing throughout the entire body of the sealing material, much quicker than one-part sealant compositions. However, problems exist.

It is frequently desirable that the two-part moisture cure organopolysiloxane compositions cure quickly enough to provide a sound seal within several hours but not so quickly that the surface cannot be tooled to a desired configuration shortly after application onto a target substrate surface. That said, in many applications, such as insulating glass, it is important for a two-part sealant to build bulk mechanical properties (such as elastic modulus or hardness as measured by durometer measurements) quickly so that substrates to which they have been applied can be moved soon after assembly, reducing work in progress (WIP). This can be achieved by increasing cure speed by adjusting tin-based catalyst and/or aminosilane levels (when e.g., functioning as an adhesion promoter). However, increasing the speed of cure comes with the drawback that it reduces the period of time during which the composition can be tooled into a desired shape/position before cure and reduces the tack-free time. Furthermore, relying on fast-curing two-part moisture cure organopolysiloxane compositions can reduce static mixer life and negatively impact productivity for the end user as changing static mixers results in down time and increased base purges wastes material.

Furthermore, in two-part formulations the base part comprising the organopolysiloxane polymer and filler is typically present in a significantly bigger proportion than the catalyst part, i.e., whilst the weight: weight ratio or volume:volume ratio of base:catalyst package can be 1:1, it is often much greater than e.g., 10:1 or even higher. When the ratio is e.g., 10:1 the catalyst package needs to contain high concentrations of active ingredients such as catalysts, cross-linkers and aminosilanes in order to deliver adequate functionality for curing and adhesion. High concentrations of primary amine and tin catalyst in the catalyst package that can induce random chain scission of trimethylsiloxy-terminated polydimethylsiloxane carrier fluid, thus reducing the continuous phase viscosity and increasing the velocity of particle settling.

Another issue which can be even more significant is that catalyst packages of the type described above may have miscibility issues, especially during storage for extended periods of time. This tends to cause the standard trimethylsilyl-terminated polydimethylsiloxane carrier liquid to phase separate by forming an upper layer and the filler settling to the bottom of the mixture in a silane rich lower phase, rendering re-mixing on a large scale, at least problematic but in extreme cases particularly on an industrial scale, when significant phase separation is evident, can lead to the catalyst package having to be replaced.

As a result of the above phase separation, the storage stability of the catalyst package may be dramatically impacted. Phase separation is a significant issue for end users. It is extremely messy and time consuming to remix the catalyst package of such two-part moisture cure organopolysiloxane compositions before use, after a storage period, especially on a large scale as some of the catalysts used can be flammable thereby causing a potential safety hazard.

It has been previously identified in WO2019027897 that one way of successfully avoiding phase separation in a catalyst package during storage is by using dipodal silanes which are compatible with a polydialkylsiloxane having the general formula:

R³₃—Si—O—((R²)₂SiO)_{d}—Si—R³₃ (2)
where R² is an alkyl or phenyl group, each R³ group may be the same or different and are selected from R² alkyl, phenyl, alkenyl or alkynyl groups having a viscosity of from about 5 to about 100,000 mPa·s at 25° C., i.e., d is an integer which provides this viscosity range. Such a combination appeared to solve the problem of phase separation, but it was found that such compositions proved to be very slow with respect to the development (build) of adhesion.

Hence, there is a need to provide a two-part moisture cure organopolysiloxane compositions such as cure adhesives/sealant compositions in which a catalyst package is provided which overcomes these long-known issues.

There is provided herein a two-part moisture curing silicone composition having a base part and catalyst package part in which, the catalyst package comprises:
(i) a carrier fluid which is one or more silicon-free, linear or branched polyethers comprising repeating units having the average formula (—CₙH₂ₙ—O—)_{y} wherein n is an integer from 3 to 6 inclusive and y is at least four, comprising one or more —OH terminal groups, —OR¹⁰ terminal groups or —OH and —OR¹⁰ terminal groups where R¹⁰ is an optionally functionalised hydrocarbon group having from 1 to 12 carbons;
(ii) a cross-linker of the structure R⁵_{c}—Si—R⁶_{4c} wherein each R⁵ is an alkoxy group having from 1 to 10 carbons, a ketoximino group or an alkenyloxy group; each R⁶ is selected from is a non-hydrolysable silicon-bonded organic group, and c is 2, 3 or 4.
(iii) an aminosilane;
(iv) a tin-based catalyst and optionally
(v) a reinforcing filler, a non-reinforcing filler or a mixture of reinforcing filler and non-reinforcing filler.

In the two-part moisture curing silicone composition described above, the base part may comprise:
(a) A siloxane polymer having at least two terminal hydroxyl or hydrolysable groups having a viscosity of from 1000 to 200,000, alternatively 2000 to 150,000 mPa·s at 25° C.;
(b) One or more reinforcing fillers; and optionally
(c) One or more non-reinforcing fillers.

There is also provided herein the use of silicon-free, linear or branched polyethers comprising repeating units having the average formula (—CₙH₂ₙ—O—)_{y} wherein n is an integer from 3 to 6 inclusive and y is at least four, comprising one or more —OH terminal groups, —OR¹⁰ terminal groups or —OH and —OR¹⁰ terminal groups where R¹⁰ is an optionally functionalised hydrocarbon group having from 1 to 12 carbons as a carrier fluid (i) in a catalyst package otherwise comprising;
(ii) a cross-linker of the structure R⁵_{c}—Si—R⁶_{4-c} wherein each R⁵ is an alkoxy group having from 1 to 10 carbons, a ketoximino group or an alkenyloxy group; each R⁶ is selected from is a non-hydrolysable silicon-bonded organic group, and c is 2, 3 or 4.
(iii) an aminosilane;
(iv) a tin-based catalyst and optionally
(v) a reinforcing filler, a non-reinforcing filler or a mixture of reinforcing filler and non-reinforcing filler;
   for a two-part moisture curing silicone composition having a base part and the aforementioned catalyst package part.

The catalyst package of the two-part moisture cure organopolysiloxane composition described above utilizes an alternative carrier fluid from the industry standard trimethylsiloxy-terminated polydimethylsiloxane, namely the one or more silicon-free, linear or branched polyethers identified above as carrier fluid (i). It was surprisingly found that using this new carrier fluid results in the catalyst package exhibited markedly less phase separation than catalyst packages using said trimethylsiloxy-terminated polydimethylsiloxane.

It was found that, when using carrier fluid (i) together with the other ingredients (ii) to (iv) and optionally (v) of the catalyst package, a fully compatible, shelf stable continuous phase was generated. In particular it was found that the carrier fluid (i) and aminosilanes (iii) were miscible after mixing and did not separate over time. Hence, using carrier fluid (i) in the catalyst package enabled the use of aminosilanes as described herein in the catalyst package without phase separation which is often seen after storage when the carrier fluid is the industry standard trimethylsiloxy-terminated polydimethylsiloxane. Furthermore, it would appear that the use of one or more silicon-free, linear or branched polyethers as carrier fluid (i) as described herein provides the desired combination of storage stability in the catalyst package without sacrificing adhesion, cure rate or other critical performance properties in the cured product, in particular when the catalyst package and base composition are mixed together. In comparison when industry standard trimethylsiloxy-terminated polydimethylsiloxanes are utilized as the carrier fluid in a catalyst package, increasing the amount of aminosilane present tends to cause random chain scission of the trimethylsiloxy-terminated polydimethylsiloxane leading to a significant viscosity decrease of the catalyst package and an acceleration in the settling of the fillers out of the continuous phase.

Also, the aminosilanes and trimethylsiloxy-terminated polydimethylsiloxanes are not very compatible and as such when increasing amounts of aminosilanes are introduced into the catalyst package formulation, there is an increasing tendency for phase separation to occur. As a result of the above phenomena, the storage stability of the catalyst package material will be dramatically impacted.

In the disclosure herein replacing industry standard trimethylsiloxy-terminated polydimethylsiloxanes with carrier fluid (i) has no negative effect on adhesion of the two-part moisture cure organopolysiloxane composition once mixed together and applied onto a substrate surface. Once cured the sealant as described herein retains cohesive failure to a variety of substrates, including glass and many glass coatings such as Low-E type coatings. Low-E coated glass is glass that has a colorless, ultra-thin reflective coating on the glass which limits the level of UV light able to pass through the glass. Such coatings can be difficult for silicone sealants to adhere to.

An Additional Benefit was Identified when Using the Catalyst Package
defined herein in that an improved (faster) bulk durometer build (which is indicative of the rate of curing in deep sections) was observed with no impact to cure speed as compared to catalyst packages utilizing industry standard trimethylsiloxy-terminated polydimethylsiloxanes as the carrier fluid.

For the avoidance of doubt, bulk durometer build refers to the durometer (e.g., Shore A) of the bulk of a sampled material that is not the surface material facing the open environment, for example where the sealant meets the substrate or the sealant/air interface. This is because, for example, a sealant surface at the interface with air will cure faster and be higher in durometer than composition curing in the bulk of the composition. In general, the bulk durometer values gradually increase with time and then plateau when the sample is fully cured, however it is advantageous for the end user if the bulk durometer is greater earlier because the industrial user of such materials is generally seeking the bulk durometer to build quickly to enable end products on which they are applied to be moved faster after application reducing the work in progress (WIP). It is a significant benefit that this can be achieved without the need to add additional catalyst or aminosilane as this avoids significant reductions in tooling time and the tack free time.

### Catalyst Package

In the catalyst package described herein there are the following ingredients:
(i) a carrier fluid which is one or more silicon-free, linear or branched polyethers comprising repeating units having the average formula (—CₙH₂ₙ—O—)_{y} wherein n is an integer from 3 to 6 inclusive and y is at least four, comprising one or more —OH terminal groups, —OR¹⁰ terminal groups or —OH and —OR¹⁰ terminal groups where R¹⁰ is an optionally functionalised hydrocarbon group having from 1 to 12 carbons;
(ii) a cross-linker of the structure R %_{c}—Si—R⁶_{4-c} wherein each R⁵ is an alkoxy group having from 1 to 10 carbons, a ketoximino group or an alkenyloxy group; each R⁶ is selected from is a non-hydrolysable silicon-bonded organic group, and c is 2, 3 or 4.
(iii) an aminosilane;
(iv) a tin-based catalyst and optionally
(v) a reinforcing filler, a non-reinforcing filler or a mixture of reinforcing filler and non-reinforcing filler

### Carrier Fluid (i)

The carrier fluid (i) in the catalyst package is a silicon-free, linear or branched polyether comprising repeating units having the average formula (—CₙH₂ₙ—O—)_{y} wherein n is an integer from 3 to 6 inclusive and y (the number average degree of polymerization) is at least four, comprising one or more —OH terminal groups, —OR¹⁰ terminal groups or —OH and —OR¹⁰ terminal groups where R¹⁰ is an optionally functionalised hydrocarbon group having from 1 to 12 carbons. Other suitable terminal groups may additionally be present if required or desired.

The groups with average formula (—CₙH₂ₙ—O—)_{y} wherein n is an integer from 3 to 6 inclusive and y is at least four, are not necessarily identical throughout the polyoxyalkylene, but can differ from unit to unit and may comprise for the sake of example:
trimethylene oxide units (—[CH₂—CH₂—CH₂—O]—),
tetramethylene oxide units (—[CH₂—CH₂—CH₂—CH₂—O]—),
oxypropylene units (—[CH(CH₃)—CH₂—O]—) and/or
oxybutylene units (—[CH(CH₂CH₃)—CH₂—O]—).

The silicon-free, linear or branched polyether comprising groups having the average formula (—CₙH₂ₙ—O—)_{y} wherein n is an integer from 3 to 6 inclusive and y is at least four, comprising one or more —OH terminal groups, —OR¹⁰ terminal groups or —OH and —OR¹⁰ terminal groups where R¹⁰ is an optionally functionalised hydrocarbon group having from 1 to 12 carbons may optionally contain small amounts of other organic (silicon-free) monomers copolymerised therein. For example, ethylene oxide units (—[CH₂—CH₂—O]—) in an amount of up to about 5 wt. % of the polyether, alternatively up to about 10 wt. % of the polyether.

Subscript y, the number average degree of polymerization of the polyether, is at least 4; and can be determined by dividing the number average molecular weight (Mn) minus the formula weight of the end groups by the formula weight of the repeating units where e.g.:
oxypropylene unit formula weight=58.08 g/mol,
oxybutylene unit formula weight=72.10 g/mol,
oxyhexylene unit formula weight=100.16 g/mol, and
ethyleneoxy unit formula weight=44.05 g/mol.

The number average molecular weight (Mn) of each polyether may range from about 200 to 750,000 g/mol, alternatively from about 300 to 500,000 g/mol, alternatively from about 1000 to 250,000 g/mol, alternatively from about 2500 to 100,000 g/mol, alternatively from about 5,000 to around 60,000 g/mol, determined by gel permeation chromatography using polystyrene standards.

When terminal groups are —OR¹⁰ terminal groups, R¹⁰ is an optionally functionalised hydrocarbon group having from 1 to 12 carbons, for example, R¹⁰ may be an alkyl group having from 1 to 12 carbons, alternatively 1 to 6 carbons, an aryl group such as a phenyl group, a hydrocarbon having functional groups such as an acetyl group (—C(CH₃)═O) an amine or ester or may be an unsaturated hydrocarbon group such as an allyl group (—CH₂—CH═CH₂) or methallyl group (—CH₂—C(CH₃)═CH₂). However, R¹⁰ is both Si-free and stable in the presence of the other components (ii), (iii), and (iv) of the catalyst package.

The polyethers utilized as carrier fluid (i) herein may be made by any suitable process. For example, linear polyethers can be produced by methods known in the art such as by ring opening polymerization of the corresponding oxirane structure such as propylene oxide, 1,2-butylene oxide, or tetrahydrofuran from initiators such as water, ethylene glycol, 1,2-propylene glycol, and ethylene diamine, while branched polyethers can be produced similarly by known methods utilizing multi-functional initiators such glycerine, trimethylolpropane, sorbitol, sucrose, pentaerythritol, triethanol amine, diethylene triamine, 4′,4′-diphenyl methane diamine, or o-toluene diamines such as 2,4 as toluene diamine and 2,6 toluene diamine.

Typically, the carrier fluid (i), is present in the catalyst package in an amount of from 30 to 80 weight % (wt. %), alternatively 40 to 65 wt. % of the total weight of the catalyst package.

### Cross-Linker (ii)

Cross-linker (ii) utilized herein has the structure R⁵_{c}—Si—R⁶_{4-c}, wherein each R⁵ is an alkoxy group having from 1 to 10 carbons, each R⁶ is selected from is a non-hydrolysable silicon-bonded organic group, and c is 2, 3 or 4. Each R⁵ may be a ketoximino group (for example dimethyl ketoximo, and isobutylketoximino); an alkoxy group (for example methoxy, ethoxy, iso-butoxy and propoxy) or an alkenyloxy groups (for example isopropenyloxy and 1-ethyl-2-methylvinyloxy). For example, R⁵ may be the sake of example methoxy, ethoxy, propoxy iso-propoxy, butoxy, t-butoxy, pentoxy (amyloxy), isopentoxy (isoamyloxy), hexoxy and isohexoxy.

In one embodiment all R⁵ groups present are the same. Each R⁶ group may be any suitable non-hydrolysable silicon-bonded organic group, such as an alkyl group having from 1 to 6 carbons (for example methyl, ethyl, propyl, and butyl); an alkenyl group having from 2 to 6 carbons, (for example vinyl and allyl) cycloalkyl groups (for example cyclopentyl and cyclohexyl); aryl groups (for example phenyl, and tolyl); aralkyl groups (for example 2-phenylethyl). It will be seen that subscript c maybe 2, 3 or 4. Typically, crosslinker (ii) may only function as a cross-linker when subscript c is 2 if, the polymer present in the base part composition comprises more than two —OH or hydrolysable groups per molecule otherwise it will solely cause chain-extension and not functioning as a cross-linker. Preferably subscript c is either 3 or 4 for cross-linking purposes but it is to be understood that in some cases, it is desirable to include a fraction of di(alkoxy) functional silanes (c=2) in a mixture with tri or tetrafunctional alkoxysilanes (c=3 or 4) to impart chain-extension and flexibility.

Silanes which can be used as cross-linkers (ii) include bis (trimethoxysilyl)hexane, 1,2-bis (triethoxysilyl)ethane, alkyltrialkoxysilanes such as methyltrimethoxysilane (MTM) and methyltriethoxysilane, alkenyltrialkoxy silanes such as vinyltrimethoxysilane and vinyltriethoxysilane, isobutyltrimethoxysilane (iB™). Other suitable silanes include ethyltrimethoxysilane, phenyltrimethoxysilane, 3,3,3-trifluoropropyltrimethoxysilane, cyanoethyltrimethoxysilane, tetramethoxysilane, tetraethoxysilane (tetraethyl orthosilicate), tetrapropoxysilane (tetrapropyl orthosilicate) and tetrapentoxysilane (tetraamyl orthosilicate); or alternatively alkoxytrioximosilane, alkenyltrioximosilane, methyltris(methylethylketoximo)silane, vinyl-tris-methylethylketoximo)silane, methyltris(methylethylketoximino)silane, alkenyl alkyl dialkoxysilanes such as vinyl methyl dimethoxysilane, vinyl ethyldimethoxysilane, vinyl methyldiethoxysilane, vinylethyldiethoxysilane, alkenylalkyldioximosilanes such as vinyl methyl dioximosilane, vinyl ethyldioximosilane, vinyl methyldioximosilane, vinylethyldioximosilane and/or methylphenyl-dimethoxysilane. The cross-linker (ii) used may also comprise any combination of two or more of the above. The catalyst package may comprise from 1 to 30 wt. % of cross-linker (ii), alternatively 5 to 25 wt. % of cross-linker (ii).

Aminosilanes (iii)

The aminosilanes incorporated in the catalyst package for the two-part moisture curing silicone compositions described herein may function as adhesion promoters. Examples of aminosilane (iii) which are incorporated in the catalyst package for the two-part moisture curing silicone compositions described herein include (N-phenylamino)methyltrimethoxysilane, aminomethyltrimethoxysilane, diethylarmoinmethyldiehoysilane, diethylaminomethyhriethoxysilane, (ethylenediaminepropyl)trimethoxy silane, aminoalkylalkoxysilanes, for example gamma-aminopropyltriethoxysilane or gamma-aminopropyltrimethoxysilane. Further suitable aminosilanes (iii) are reaction products of epoxyalkylalkoxysilanes, such as 3-glycidoxypropyltrimethoxysilane with amino-substituted alkoxysilanes such as 3-aminopropyltrimethoxysilane and optionally with alkylalkoxysilanes such as methyltrimethoxysilane. Typically, the aminosilanes (iii) are present in a range of from 1 to 25 wt. % of the catalyst package, alternatively 2 to 20 wt. % of the catalyst package.

### Tin-Based Catalyst (iv)

The fourth essential ingredient in the catalyst package is a suitable tin-based condensation catalyst (iv) which is for use as the catalyst for the cure reaction subsequent to mixing the base part and catalyst package part together. Examples include tin triflates, organic tin metal catalysts such as triethyltin tartrate, tin octoate, tin oleate, tin naphthenate, butyltintri-2-ethylhexoate, tinbutyrate, carbomethoxyphenyl tin trisuberate, isobutyltintriceroate, and diorganotin salts especially diorganotin dicarboxylate compounds such as dibutyltin dilaurate (DBTDL), dioctyltin dilaurate (DOTDL), dimethyltin dibutyrate, dibutyltin dimethoxide, dibutyltin diacetate (DBTDA), dibutyltin bis(2,4-pentanedionate), dibutyltin dibenzoate, stannous octoate, dimethyltin dineodecanoate (DMTDN) dioctyltin dineodecanoate (DOTDN) and dibutyltin dioctoate.

The tin catalyst may be present in an amount of from 0.01 to 3 wt. % of the catalyst package; alternatively, 0.05 to 1.5 wt. % of the catalyst package, alternatively, 0.05 to 0.75 wt. % of the catalyst package.

### Fillers (v)

The reinforcing filler (v) when present may contain one or more reinforcing fillers such as calcium carbonate, high surface area fumed silica and/or precipitated silica including, for example, rice hull ash. Reinforcing filler (v) may contain one or more finely divided, reinforcing fillers such as precipitated calcium carbonate, ground calcium carbonate, fumed silica, colloidal silica and/or precipitated silica.

Typically, the surface area of the reinforcing filler (v) is at least 15 m²/g in the case of precipitated calcium carbonate measured in accordance with the BET method in accordance with ISO 9277: 2010, alternatively 15 to 50 m²/g, alternatively, 15 to 25 m²/g in the case of precipitated calcium carbonate. Silica reinforcing fillers have a typical surface area of at least 50 m²/g. In one embodiment reinforcing filler (v) is a precipitated calcium carbonate, precipitated silica and/or fumed silica; alternatively, precipitated calcium carbonate. In the case of high surface area fumed silica and/or high surface area precipitated silica, these may have surface areas of from 75 to 400 m²/g measured using the BET method in accordance with ISO 9277: 2010, alternatively of from 100 to 300 m²/g using the BET method in accordance with ISO 9277: 2010.

The optional non-reinforcing filler may comprise non-reinforcing fillers such as crushed quartz, diatomaceous earths, barium sulphate, iron oxide, titanium dioxide and carbon black, talc, wollastonite. Other fillers which might be used alone or in addition to the above include aluminite, calcium sulphate (anhydrite), gypsum, calcium sulphate, magnesium carbonate, clays such as kaolin, aluminium trihydroxide, magnesium hydroxide (brucite), graphite, copper carbonate, e.g., malachite, nickel carbonate, e.g., zarachite, barium carbonate, e.g., witherite and/or strontium carbonate e.g., strontianite.

Aluminium oxide, silicates from the group consisting of olivine group; garnet group; aluminosilicates; ring silicates; chain silicates; and sheet silicates. The olivine group comprises silicate minerals, such as but not limited to, forsterite and Mg₂SiO₄. The garnet group comprises ground silicate minerals, such as but not limited to, pyrope; Mg₃Al₂S₁₃O₁₂; grossular; and Ca₂Al₂S₁₃O₁₂. Aluminosilicates comprise ground silicate minerals, such as but not limited to, sillimanite; Al₂SiO₅; mullite; 3Al₂O₃·2SiO₂; kyanite; and Al₂SiO₅.

The ring silicates group comprises silicate minerals, such as but not limited to, cordierite and Al₃(Mg,Fe)₂[S₁₄AlO₁₈]. The chain silicates group comprises ground silicate minerals, such as but not limited to, wollastonite and Ca[SiO₃].

The sheet silicates group comprises silicate minerals, such as but not limited to, mica; K₂AI₁₄[S₁₆Al₂O₂₀](OH)₄; pyrophyllite; Al₄[S₁₈O₂₀](OH)₄; talc; Mg₆[S₁₈O₂₀](OH)₄; serpentine for example, asbestos; Kaolinite; Al₄[S₁₄O₁₀](OH)₈; and vermiculite. The optional non-reinforcing filler, when present, is present in an amount up to 20 wt. % of the base.

Filler (v) may be hydrophobically treated for example with one or more aliphatic acids, e.g., a fatty acid such as stearic acid or a fatty acid ester such as a stearate, or with organosilanes, organosiloxanes, or organosilazanes hexaalkyl disilazane or short chain siloxane diols to render the filler(s) (v) hydrophobic and therefore easier to handle and obtain a homogeneous mixture with the other adhesive components. These surface modified fillers do not clump. The fillers may be pre-treated or may be treated in situ.

Fillers (v) may be present in the catalyst package in an amount of from 0 to 50 wt. % depending on the mixing ratio of the two-parts of the two-part moisture cure organopolysiloxane composition.

### Additives

The catalyst package may also include one or more additives if desired. These may include additional non-amino adhesion promoters, adhesion catalysts, pigments and/or colorants, rheology modifiers, flame retardants, stabilizers such as antioxidants, UV and/or light stabilizers and fungicides and/or biocides and the like. It will be appreciated that some of the additives are included in more than one list of additives. Such additives would then have the ability to function in all the different ways referred to. For example, pigments and/or coloured (non-white) fillers e.g., carbon black may be utilized in the catalyst package to colour the end sealant product. When present carbon black will function as both a non-reinforcing filler and pigment/colorant.

### Non-Amino Adhesion Promoters

One or more non-amino adhesion promoters may be utilised in the composition herein. These may include, for the same of example, epoxyalkylalkoxysilanes, for example, 3-glycidoxypropyltrimethoxysilane and glycidoxypropyltriethoxysilane, mercapto-alkylalkoxysilanes, and reaction products of ethylenediamine with silylacrylates, isocyanurates containing silicon groups such as 1, 3, 5-tris(trialkoxysilylalkyl) isocyanurates or mixtures thereof.

### Pigments

The two-part moisture cure organopolysiloxane composition as described herein may further comprise one or more pigments and/or colorants which may be added if desired. The pigments and/or colorants may be coloured, white, black, metal effect, and luminescent e.g., fluorescent and phosphorescent. Pigments are utilized to colour the composition as required. Any suitable pigment may be utilized providing it is compatible with the composition herein. In two-part moisture cure organopolysiloxane compositions pigments and/or coloured (non-white) fillers e.g., carbon black may be utilized in the catalyst package to colour the end sealant product.

Suitable white pigments and/or colorants include titanium dioxide, zinc oxide, lead oxide, zinc sulfide, lithophone, zirconium oxide, and antimony oxide.

Suitable non-white inorganic pigments and/or colorants include, but are not limited to, iron oxide pigments such as goethite, lepidocrocite, hematite, maghemite, and magnetite black iron oxide, yellow iron oxide, brown iron oxide, and red iron oxide; blue iron pigments; chromium oxide pigments; cadmium pigments such as cadmium yellow, cadmium red, and cadmium cinnabar; bismuth pigments such as bismuth vanadate and bismuth vanadate molybdate; mixed metal oxide pigments such as cobalt titanate green; chromate and molybdate pigments such as chromium yellow, molybdate red, and molybdate orange; ultramarine pigments; cobalt oxide pigments; nickel antimony titanates; lead chrome; carbon black; lampblack, and metal effect pigments such as aluminium, copper, copper oxide, bronze, stainless steel, nickel, zinc, and brass.

Suitable organic non-white pigments and/or colorants include phthalocyanine pigments, e.g. phthalocyanine blue and phthalocyanine green; monoarylide yellow, diarylide yellow, benzimidazolone yellow, heterocyclic yellow, DAN orange, quinacridone pigments, e.g. quinacridone magenta and quinacridone violet; organic reds, including metallized azo reds and nonmetallized azo reds and other azo pigments, monoazo pigments, diazo pigments, azo pigment lakes, β-naphthol pigments, naphthol AS pigments, benzimidazolone pigments, diazo condensation pigment, isoindolinone, and isoindoline pigments, polycyclic pigments, perylene and perinone pigments, thioindigo pigments, anthrapyrimidone pigments, flavanthrone pigments, anthanthrone pigments, dioxazine pigments, triarylcarbonium pigments, quinophthalone pigments, and diketopyrrolo pyrrole pigments.

Typically, the pigments and/or colorants, when particulates, have average particle diameters in the range of from 10 nm to 50 μm, preferably in the range of from 40 nm to 2 μm. The pigments and/or colorants when present are present in the range of from 2, alternatively from 3, alternatively from 5 to 20 wt. % of the catalyst package composition, alternatively to 15 wt. % of the catalyst package composition, alternatively to 10 wt. % of the catalyst package composition.

### Flame Retardants

Flame retardants may include aluminium trihydroxide and magnesium dihydroxide, iron oxides, triphenyl phosphate, dimethyl methylphosphonate, tris(2,3-dibromopropyl) phosphate (brominated tris), halogenated flame retardants such as chlorinated paraffins and hexabromocyclododecane, and mixtures or derivatives thereof.

### Antioxidants

Any suitable antioxidant(s) may be utilized, if deemed required. Examples may include: ethylene bis (oxyethylene) bis(3-tert-butyl-4-hydroxy-5(methylhydrocinnamate) 36443-68-2; tetrakis[methylene(3,5-di-tert-butyl-4-hydroxy hydrocinnamate)]methane 6683-19-8; octadecyl 3,5-di-tert-butyl-4-hydroxyhyrocinnamate 2082-79-3; N,N′-hexamethylene-bis (3,5-di-tert-butyl-4-hydroxyhyrocinnamamide) 23128-74-7; 3,5-di-tert-butyl-4-hydroxyhydrocinnamic acid, C7-9 branched alkyl esters 125643-61-0; N-phenylbenzene amine, reaction products with 2,4,4-trimethylpentene 68411-46-1; e.g. anti-oxidants sold under the Irganox© name from BASF.

UV and/or Light Stabilizers

UV and/or light stabilizers may include, for the sake of example include benzotriazole, ultraviolet light absorbers and/or hindered amine light stabilizers (HALS) such as the TINUVIN® product line from Ciba Specialty Chemicals Inc.

### Biocides

Biocides may additionally be utilized in the two-part moisture cure organopolysiloxane composition if required. It is intended that the term “biocides” includes bactericides, fungicides and algicides, and the like. Suitable examples of useful biocides which may be utilized in compositions as described herein include, for the sake of example:

Carbamates such as methyl-N-benzimidazol-2-ylcarbamate (carbendazim) and other suitable carbamates, 10, 10′-oxybisphenoxarsine, 2-(4-thiazolyl)-benzimidazole, N-(fluorodichloromethylthio)phthalimide, diiodomethyl p-tolyl sulfone, if appropriate in combination with a UV stabilizer, such as 2,6-di(tert-butyl)-p-cresol, 3-iodo-2-propinyl butylcarbamate (IPBC), zinc 2-pyridinethiol 1-oxide, triazolyl compounds and isothiazolinones, such as 4,5-dichloro-2-(n-octyl)-4-isothiazolin-3-one (DCOIT), 2-(n-octyl)-4-isothiazolin-3-one (OIT) and n-butyl-1,2-benzisothiazolin-3-one (BBIT). Other biocides might include for example Zinc Pyridinethione, 1-(4-Chlorophenyl)-4,4-dimethyl-3-(1,2,4-triazol-1-ylmethyl)pentan-3-ol and/or 1-[[2-(2,4-dichlorophenyl)-4-propyl-1,3-dioxolan-2-yl]methyl]-1H-1,2,4-triazole. The fungicide and/or biocide may suitably be present in an amount of from 0 to 0.3 wt. % of the catalyst package composition and may be present in an encapsulated form where required such as described in EP2106418.

In one alternative, the catalyst package does not comprise
An (R⁸O)ₘ(Y⁴)₃₋ₘ— Si terminated polyether, where R⁸ is a C₁₋₁₀ alkyl group, Y⁴ is an alkyl groups containing from 1 to 8 carbons and m is 1, 2 or 3;
and/or
One or more dipodal silanes in accordance with the formula:
(R⁸O)ₘ(Y⁴)₃₋ₘ—Si (CH₂)ₓ—(NHCH₂CH₂)ₜ—Q¹(CH₂)ₓ—Si(OR⁸)ₘ(Y⁴)₃₋ₘ, where R⁸ is a C₁₋₁₀ alkyl group, Y⁴ is an alkyl groups containing from 1 to 8 carbons, Q¹ is a chemical group containing a heteroatom with a lone pair of electrons; each x is an integer of from 1 to 6, t is 0 or 1 and each m is independently 1, 2 or 3.

### Base Part

Any suitable base part may be utilized. For example, the base part may comprise:
(a) A siloxane polymer having at least two terminal hydroxyl or hydrolysable groups having a viscosity of from 1000 to 200,000 mPa·s at 25° C.;
(b) One or more reinforcing fillers; and optionally
(c) One or more non-reinforcing fillers

Unless otherwise indicated all viscosity measurement given are zero-shear viscosity (ηₒ) values, obtained by extrapolating to zero the value taken at low shear rates (or simply taking an average of values) in the limit where the viscosity-shear rate curve is rate-independent, which is a test-method independent value provided a suitable, properly operating rheometer is used. For example, the zero-shear viscosity of a substance at 25° C. may be obtained by using commercial rheometers such as an Anton-Parr MCR-301 rheometer or a TA Instruments AR-2000 rheometer equipped with cone-and-plate fixtures of suitable diameter to generate adequate torque signal at a series of low shear rates, such as 0.01 s⁻¹, 0.1 s⁻¹ and 1.0 s⁻¹ while not exceeding the torque limits of the transducer. Alternatively, the viscosity measurements may be obtained using an ARES-G2 rotational rheometer, commercially available from TA Instruments using a steady rate sweep from 0.1 to 10 s⁻¹ on a 25 mm cone and plate. If the zero-shear plateau region cannot be observed at shear rates accessible to the rheometer or viscometer, we report the viscosity measured at a standard shear rate of 0.1 s⁻¹at 25° C.

The base part may comprise (a) a siloxane polymer having at least two i.e., having 2 or more terminal hydroxyl or hydrolysable groups having a viscosity of from 1000 to 200,000 mPa·s at 25° C., alternatively 2000 to 150000 mPa·s at 25° C. The siloxane polymer (a) may be described by the following molecular Formula (1)

X₃₋ₐRₐSi—Z_{b}—O—(R¹_{y}SiO_{(4-y)/2})_{z}—Z_{b}—Si—RₐX₃₋ₐ (1)
where
   a is 0, 1, 2 or 3,
   b is 0 or 1,
   z is an integer from 300 to 5000 inclusive,
   y is 0, 1 or 2 preferably 2.
   At least 97% (i.e., from 97% to 100%) of the R¹_{y}SiO_{(4-y)/2} are characterized with y=2.
   X is a hydroxyl group or any condensable or any hydrolyzable group,
   Each Z is independently selected from an alkylene group having from 1 to 10 carbon atoms.

Each R is individually selected from aliphatic organic groups selected from alkyl, aminoalkyl, polyaminoalkyl, epoxyalkyl or alkenyl alternatively alkyl, aminoalkyl, polyaminoalkyl, epoxyalkyl groups having, in each case, from 1 to 10 carbon atoms per group or alkenyl groups having in each case from 2 to 10 carbon atoms per group or is an aromatic aryl group, alternatively an aromatic aryl group having from 6 to 20 carbon atoms. Most preferred are the methyl, ethyl, octyl, vinyl, allyl and phenyl groups.

Each R¹ is individually selected from the group consisting of X, alkyl groups, alternatively alkyl groups having from 1 to 10 carbon atoms, alkenyl groups alternatively alkenyl groups having from 2 to 10 carbon atoms and aromatic groups, alternatively aromatic groups having from 6 to 20 carbon atoms. Most preferred are methyl, ethyl, octyl, trifluoropropyl, vinyl and phenyl groups. It is possible that some R¹ groups may be siloxane branches off the polymer backbone which may have terminal groups as hereinbefore described.

Most preferred R¹ is methyl.

Each X group of siloxane polymer (a) may be the same or different and can be a hydroxyl group or a condensable or hydrolyzable group. The term “hydrolyzable group” means any group attached to the silicon which is hydrolyzed by water at room temperature. The hydrolyzable group X includes groups of the Formula —OT, where T is an alkyl group such as methyl, ethyl, isopropyl, octadecyl, an alkenyl group such as allyl, hexenyl, cyclic groups such as cyclohexyl, phenyl, benzyl, beta-phenylethyl; hydrocarbon ether groups, such as 2-methoxyethyl, 2-ethoxyisopropyl, 2-butoxyisobutyl, p-methoxyphenyl or —(CH₂CH₂O)₂CH₃; or any N,N-amino radical, such as dimethylamino, diethylamino, ethylmethylamino, diphenylamino or dicyclohexylamino.

The most preferred X groups are hydroxyl groups or alkoxy groups. Illustrative alkoxy groups are methoxy, ethoxy, propoxy, isopropoxy, butoxy, isobutoxy, pentoxy, hexoxy octadecyloxy and 2-ethylhexoxy; dialkoxy radicals, such as methoxymethoxy or ethoxymethoxy and alkoxyaryloxy, such as ethoxyphenoxy. The most preferred alkoxy groups are methoxy or ethoxy.

Each Z is independently selected from an alkylene group having from 1 to 10 carbon atoms. In one alternative each Z is independently selected from an alkylene group having from 2 to 6 carbon atoms; in a further alternative each Z is independently selected from an alkylene group having from 2 to 4 carbon atoms.

Siloxane polymer (a) of the base part can be a single siloxane represented by Formula (1) or it can be mixtures of siloxanes represented by the aforesaid formula. The term “siloxane polymer mixture” in respect to component (a) of the base part is meant to include any individual siloxane polymer (a) or mixtures of siloxane polymers (a). As used herein, the term “silicone content” means the total amount of silicone used in the base part and the catalyst package, irrespective of the source, including, but not limited to the siloxane polymer (a), polymer mixtures, and/or resins.

As previously discussed, the number average Degree of Polymerization (DP), (i.e., in the above formula substantially z), describes the average number of monomeric units in a macromolecule or polymer or oligomer molecule of silicone. Synthetic polymers invariably consist of a mixture of macromolecular species with different degrees of polymerization and therefore of different molecular weights. There are several commonly defined average polymer molecular weights representing various moments of the molecular weight distribution, which can be measured with different techniques. The two most widely reported are the number average molecular weight (Mn) and the weight average molecular weight (Mw). The Mn and Mw of a linear silicone polymer can be determined by Gel permeation chromatography (GPC) in a solvent like toluene using polystyrene calibration standards with precision of about 10-15%. This technique is standard and yields Mw, Mn and polydispersity index (PI). PI=Mw/Mn.

Siloxane polymer (a) is going to be present in an amount of from 20 to 90 wt. %, alternatively 20 to 80 wt. % of the base part composition, alternatively from 35 to 65 wt. % of the base part composition.

### Reinforcing Filler (b)

The reinforcing filler (b) of the base part may contain one or more finely divided, reinforcing fillers such as calcium carbonate, high surface area fumed silica and/or precipitated silica including, for example, rice hull ash. Again, typically the surface area of the reinforcing filler (b) is at least 15 m²/g in the case of precipitated calcium carbonate measured in accordance with the BET method in accordance with ISO 9277: 2010, alternatively 15 to 50 m²/g, alternatively, 15 to 25 m²/g in the case of precipitated calcium carbonate. Silica reinforcing fillers have a typical surface area of at least 50 m²/g. In one embodiment reinforcing filler (v) is a precipitated calcium carbonate, precipitated silica and/or fumed silica; alternatively, precipitated calcium carbonate. In the case of high surface area fumed silica and/or high surface area precipitated silica, these may have surface areas of from 75 to 400 m²/g measured using the BET method in accordance with ISO 9277: 2010, alternatively of from 100 to 300 m²/g using the BET method in accordance with ISO 9277: 2010.

Typically, the reinforcing fillers are present in the base part composition in an amount of from 10 to 80 wt. % of the base part composition, alternatively 20 to 70 wt. % of the base part composition, alternatively from 35 to 65% wt. % of the base part composition.

### Non-Reinforcing Filler (c)

The optional non-reinforcing filler (c) of the base part may comprise non-reinforcing fillers such as crushed quartz, diatomaceous earths, barium sulphate, iron oxide, titanium dioxide and carbon black, talc, wollastonite. Other fillers which might be used alone or in addition to the above include aluminite, calcium sulphate (anhydrite), gypsum, calcium sulphate, magnesium carbonate, clays such as kaolin, aluminium trihydroxide, magnesium hydroxide (brucite), graphite, copper carbonate, e.g., malachite, nickel carbonate, e.g., zarachite, barium carbonate, e.g., witherite and/or strontium carbonate e.g., strontianite.

Aluminium oxide, silicates from the group consisting of olivine group; garnet group; aluminosilicates; ring silicates; chain silicates; and sheet silicates. The olivine group comprises silicate minerals, such as but not limited to, forsterite and Mg₂SiO₄. The garnet group comprises ground silicate minerals, such as but not limited to, pyrope; Mg₃Al₂S₁₃O₁₂; grossular; and Ca₂Al₂S₁₃O₁₂. Aluminosilicates comprise ground silicate minerals, such as but not limited to, sillimanite; Al₂SiO₅; mullite; 3Al₂O₃0.2SiO₂; kyanite; and Al₂SiO₅.

The ring silicates group comprises silicate minerals, such as but not limited to, cordierite and Al₃(Mg,Fe)₂[S₁₄AlO₁₈]. The chain silicates group comprises ground silicate minerals, such as but not limited to, wollastonite and Ca[SiO₃].

The sheet silicates group comprises silicate minerals, such as but not limited to, mica; K₂AI₁₄[S₁₆Al₂O₂₀](OH)₄; pyrophyllite; Al₄[S₁₈O₂₀](OH)₄; talc; Mg₆[S₁₈O₂₀](OH)₄; serpentine for example, asbestos; Kaolinite; Al₄[S₁₄O₁₀](OH)₈; and vermiculite. The optional non-reinforcing filler, when present, is present in an amount up to 20 wt. % of the base.

In addition, a surface treatment of the reinforcing filler (b) of the base part and optional non-reinforcing filler (c) of the base part may be performed as described above, for example with a fatty acid or a fatty acid ester such as a stearate, or with organosilanes, organosiloxanes, or organosilazanes hexaalkyl disilazane or short chain siloxane diols to render the filler(s) hydrophobic and therefore easier to handle and obtain a homogeneous mixture with the other sealant components The surface treatment of the fillers makes them easily wetted by siloxane polymer (a) of the base part. These surface modified fillers do not clump and can be homogeneously incorporated into the silicone polymer (a) of the base part. This results in improved room temperature mechanical properties of the uncured compositions.

The proportion of such fillers when employed will depend on the properties desired in the two-part moisture cure organopolysiloxane composition and the cured elastomer. Filler (b) is going to be present in an amount of from 10 to 80 wt. % of the base part composition.

In the two-part moisture cure organopolysiloxane compositions, the base part comprises:
10 to 90 wt. % of siloxane polymer (a);
10 to 80 wt. % reinforcing fillers (b);
0 to 25 wt. % of non-reinforcing fillers (c);
   with the total wt. % of the base part being 100 wt. %
   and the catalyst package part comprises:
carrier fluid (i) in an amount of from 30 to 80 wt. % of the catalyst package composition, alternatively 40 to 65 wt. % of the catalyst package;
cross-linker (ii) in an amount of 0.5 to 25 wt. % of the catalyst package alternatively 2 to 20 wt. % of the catalyst package;
aminosilane (iii) in an amount of from 5 to 25 wt. % of the catalyst package, alternatively 2 to 20 wt. % of the catalyst package;
tin-based catalyst (iv) in an amount of from 0.01 to 3 wt. % of the catalyst package;
   alternatively, 0.05 to 1.5 wt. % of the catalyst package, alternatively, 0.05 to 0.75 wt. % of the catalyst package; and optionally
a reinforcing filler, a non-reinforcing filler or a mixture of reinforcing filler and non-reinforcing filler (v) in an amount of from in an amount of from 0 to 50 wt. % depending on the mixing ratio of the two-parts of the composition;
   with the total wt. % of the catalyst package being 100 wt. %.

In the two-part moisture cure organopolysiloxane compositions, the components of each part are mixed together in amounts within the ranges given above and then the base part composition and the catalyst package composition are inter-mixed in a predetermined ratio e.g. from 15:1 to 1:1, alternatively from 14:1 to 5:1 alternatively from 14:1 to 7:1. If the intended mixing ratio of the base part:catalyst package is 15:1 or greater, no filler will be generally utilized in the catalyst package. However, if the intended mixing ratio of the base part:catalyst package is less than 15:1 an increasing amount filler will be utilized in the catalyst package up to the maximum of 50 wt. % of the catalyst package, if the intended ratio is 1:1. The moisture curable compositions can be prepared by mixing the ingredients employing any suitable mixing equipment. In use the base part and the catalyst package are mixed together in the predefined ratios in a suitable mixer and then the resulting mixture is applied onto a target substrate surface.

A two-part moisture cure organopolysiloxane composition when utilized as a sealant composition as may be a gunnable sealant composition used for
(i) space/gap filling applications;
(ii) seal applications, such as sealing the edge of a lap joint in a construction membrane; or
(iii) seal penetration applications, e.g., sealing a vent in a construction membrane;
(iv) adhering at least two substrates together.
(v) a laminating layer between two substrates to produce a laminate of the first substrate,
the sealant product and the second substrate.

In the case of two-part moisture cure organopolysiloxane compositions e.g., silicone sealant compositions as hereinbefore described, there is also provided a method for filling a space between two substrates so as to create a seal therebetween, comprising:
a) providing a two-part moisture cure organopolysiloxane composition comprising a base part and a catalyst package composition as hereinbefore described, and either
b) applying the two-part moisture cure organopolysiloxane composition comprising a base part and a catalyst package to a first substrate, and bringing a second substrate in contact with the two-part moisture cure organopolysiloxane compositions comprising a base part and a catalyst package that has been applied to the first substrate, or
c) filling a space formed by the arrangement of a first substrate and a second substrate with the two-part moisture cure organopolysiloxane composition comprising a base part and a catalyst package and curing.

Resulting two-part moisture cure organopolysiloxane compositions containing catalyst packages as hereinbefore described may be employed in a variety of applications, for example as coating, caulking, mold making and encapsulating materials for use with substrates such as glass, aluminium, stainless steel, painted metals, powder-coated metals, and the like. In particular, they are for use in construction and/or structural glazing and/or insulating glazing applications. For example, an insulating glass unit and/or building façade element e.g., a shadow box and/or structural glazing unit and/or a gas filled insulation construction panel, which in each case is sealed with a silicone sealant composition as hereinbefore described. Other potential applications include as a lamp adhesive, e.g., for LED lamps, solar, automotive, electronics and industrial assembly and maintenance applications. It may also be used for weather proofing.

### EXAMPLES

In the present examples all viscosity measurement were taken at 25° C. and are provided as Unless otherwise indicated all viscosity measurement given are zero-shear viscosity values as defined previously, obtained using an ARES-G2 rotational rheometer (TA Instruments). Measurements were obtained using a steady rate sweep from 0.1 to 10 s⁻¹ with a 25 mm cone and plate fixture. The reported zero-shear viscosity (ηₒ) values are an average, and the polymers all displayed non-Newtonian behavior in that the viscosity was consistent across the shear rate range. Furthermore, the number average molecular weight (Mn) values provided below were determined using a Waters 2695 Separations Module equipped with a vacuum degasser, and a Waters 2414 refractive index detector (Waters Corporation of MA, USA). The analyses were performed using certified grade toluene flowing at 1.0 mL/min as the eluent, using polystyrene calibration standards. Data collection and analyses were performed using Waters Empower™ GPC software (Waters Corporation of MA, USA).

A series of catalyst packages were prepared as Examples 1 to 3 (Ex. 1 to Ex. 3) and comparative examples 1 and 2 (C. 1 & C. 2). The compositions for each catalyst package prepared is disclosed in Table 1a below. Each of the polyethers used in Ex. 1 to 3 were made with polypropylene oxide repeating units. The polyethers in Ex. 2 and Ex. 3 have —OH terminal groups whilst the polyether in Ex. 1 was end-capped with an allyl group (i.e., R in the description above was an allyl group). The comparative composition uses the same ingredients other than the carrier fluid, which is an industry standard trimethylsiloxy-terminated polydimethylsiloxane. In comparative C. 2 the carrier fluid was also an industry standard trimethylsiloxy-terminated polydimethylsiloxane but with different combinations of silanes. In a preliminary step, each of the polyethers to be used in Ex. 1 to 3 as well as the comparative alkyl-terminated diorganopolysiloxane were screened for miscibility by mixing each one with aminosilanes used in the compositions (i.e. (ethylenediaminepropyl)trimethoxysilane and the reaction product of aminopropyltriethoxysilane with glycidoxypropyltrimethoxysilane and methyltrimethoxysilane) using a Speedmixer™ DAC 600.2 VAC-P mixing device commercially available from Flacktek.

The mixtures were visually assessed for initial miscibility and watched over time for phase separation.

In each case with the polyethers used in Ex. 1, 2 and 3 a clear mixture was observed immediately after initial mixing indicating miscibility and no phase separation was observed over time. In comparison the comparative alkyl-terminated diorganopolysiloxane was hazy upon mixing, and within 24 hours displayed distinct phase separation.

The carbon black used in the following examples was SR511 commercially available from Tokai Carbon CB Ltd.

The Fumed silica used in the examples was Aerosil™ R974 commercially available from Evonik treated with dimethyldichlorosilane.

The full compositions were then prepared in accordance with Table 1a and 1b below.

TABLE 1a
Catalyst Package Compositions in wt. % of Ex. 1 to 3 and C. 1

| Component | Ex. 1 | Ex. 2 | Ex. 3 | C. 1 |
|---|---|---|---|---|
| Linear Allyl-terminated poly(propylene oxide) | 45.7 | | | |
| having a zero-shear viscosity (ηₒ) of 17,000 mPa · s at | | | | |
| 25° C. | | | | |
| Linear Hydroxyl-terminated poly(propylene oxide) | | 45.7 | | |
| (Mn 12,000) having a ηₒ of 3,600 mPa · s at 25° C. | | | | |
| Linear Hydroxyl-terminated poly(propylene oxide) | | | 45.7 | |
| (Mn 18,000) having a ηₒ of 28,000 mPa · s at 25° C. | | | | |
| trimethylsiloxy terminated polydimethylsiloxane | | | | 45.7 |
| having a ηₒ of 12,500 mPa · s at 25° C. | | | | |
| Methyltrimethoxysilane | 13 | 13 | 13 | 13 |
| Bis(trimethoxysilyl)hexane | 4 | 4 | 4 | 4 |
| Reaction product of Aminopropyltriethoxysilane | 13 | 13 | 13 | 13 |
| with Glycidoxypropyltrimethoxysilane and | | | | |
| Methyltrimethoxysilane | | | | |
| (Ethylenediaminepropyl)trimethoxysilane | 5 | 5 | 5 | 5 |
| Dimethyltindineodecanoate | 0.1 | 0.1 | 0.1 | 0.1 |
| Fumed silica | 1.9 | 1.9 | 1.9 | 1.9 |
| Carbon Black | 17.3 | 17.3 | 17.3 | 17.3 |

TABLE 1b
Composition of Comparative Example 2 (C. 2) (wt. %)

| Component | wt. % |
|---|---|
| trimethylsiloxy terminated polydimethylsiloxane having a ηₒ of | 48.75 |
| 60,000 mPa · s at 25° C. | |
| Tetraethylorthosilicate | 17.39 |
| Bis(3-triethoxysilylpropyl)amine | 17.39 |
| Carbon black | 12.68 |
| Fumed silica | 3.58 |
| Dimethyltindineodecanoate | 0.21 |

The catalyst package compositions used were prepared on a SpeedMixer™ DAC 600.2 VAC-P mixing device using 300 Max Tall cups. In each instance, All the ingredients excepting the silica and carbon black were first mixed together at 1200 revolutions per minute (rpm) for 60 seconds to form a mixture. The silica was then introduced into the mixture in two sequential batches with mixing at 1500 rpm for a further minute after each addition. The mixing cup was then scraped down before the introduction of the carbon black non-reinforcing filler/pigment. The carbon black was introduced in 3 equal parts with mixing at 1500 rpm for a further minute and scraping down the mixture after each addition. During the above preparation steps the compositions were continuously de aired continuously sequentially as follows:
30 seconds (s) at 800 revolutions per minute (rpm) and 5 psi (34.47 kPa), then
30 s at 1500 rpm and 5 psi (34.47 kPa), then
30 s at 800 rpm and 14.7 psi (101.35 kPa) and then repeat sequentially without interruption.

A standard base part composition was used for all the examples and this is detailed in Table 1b below.

TABLE 1c
Composition of Base part used for each example (wt. %)

| | Base |
|---|---|
| Component | (wt. %) |
| Treated precipitated calcium carbonate | 48 |
| Hydroxydimethyl terminated polydimethylsiloxane having a | 52 |
| ηₒ of 5000 mPa · s @ 25° C. | |

The precipitated calcium carbonate used in the base composition herein was WINNOFIL™ SPM commercially available from Imerys which had been treated with a synthetic fatty acid.

In each instance the resulting catalyst package was mixed by loading ten parts by weight of base to one-part by weight of the catalyst package in 300 Tall Speedmixer cup, then mixing on a Speedmixer™ DAC 600.2 VAC-P mixing device for one minute at 800 rpm. The resulting mixture then scraped from the bottom and sides of the cup and mixed 20 seconds at 1200 rpm. Once the mixing process had completed the resulting final composition was transferred to a Semco® tube using a hand-operated cup press.

The resulting composition was then dispensed to prepare and cure the necessary test pieces used in the following physical property and adhesion etc. testing described below.

Shore a Durometer and Tack Free Time One surprising effect observed when using the catalyst package as described herein was an unexpected faster bulk durometer build during cure without negatively impacting the cure speed. Bulk durometer build refers to the durometer of the curing composition beneath the air/composition interface and/or the sealant/substrate interface. In order to measure the bulk Shore A durometer value of the curing composition, an approximately 1 cm thick piece of mixed material is peeled off of a liner and measured at during the period when the composition is curing, testing the curing composition underneath. In order to test this the bulk Shore A durometer of the curing composition was determined after the first four-hour period of curing at room temperature (approximately 25° C.) and the results are depicted in Table 2a below. The final Shore A durometer value which was taken after curing for 7 days at room temperature (approximately 25° C.). Shore A durometer was tested in accordance with ASTM D 2240 using a Shore® Conveloader CV-71200 type A. Samples were stacked 1/2″ (1.27 cm) thick, and values reported are an average of three. The tack free time for curing samples was determined in accordance with ASTM C679-15 and the results are also provided in Table 2a

TABLE 2a
Shore A Durometer and Tack Free Time results

| | Bulk Durometer at 4 | Tack-Free | 7 Day RT Cure |
|---|---|---|---|
| | hours cure (Shore A) | Time (min) | Durometer (Sh. A) |
| Ex. 1 | 31 | 85 | 54 |
| Ex. 2 | 33 | 45 | 53 |
| Ex. 3 | 29 | 40 | 53 |
| C. 1 | 25 | 75 | 54 |
| C. 2 | 23 | 35 | 56 |

The inventive examples can be seen to be superior to the comparative 1 (C. 1) composition because they do not exhibit any phase separation, and they build bulk durometer faster.

### Tensile Strength, Elongation and Modulus

Tensile strength, elongation and modulus results were tested in accordance with ASTM D 412-06, test method A. A 100 mil (2.54 mm) thick slab of material was drawn down on a polyethylene terephthalate (PET) surface and cured seven days at room temperature and 50% relative humidity (RH). Dogbones were cut using die DIN S2 and pulled on an Alliance R/5 testing machine (MTS Systems Corp.) at 20.0 in/min (50.8 cm per minute) using a 5 kN load cell. Data were collected and analyzed using MTS Test Works Elite software v. 2.3.6. The results are Tabulated in Table 2b.

TABLE 2b
Tensile strength, elongation and modulus results

| | | | Modulus | Modulus | Modulus |
|---|---|---|---|---|---|
| | Tensile | Elongation | at 25% | at 50% | at 100% |
| | Strength | at Break | Extension | Extension | Extension |
| | (MPa) | (%) | (MPa) | (MPa) | (MPa) |
| Ex. 1 | 2.3 | 180.5 | 0.7 | 1.1 | 1.7 |
| Ex. 2 | 1.8 | 159.0 | 0.7 | 1.0 | 1.5 |
| Ex. 3 | 2.2 | 200.8 | 0.6 | 1.0 | 1.5 |
| C. 1 | 2.8 | 216.4 | 0.7 | 1.0 | 1.7 |
| C. 2 | 3.3 | 486.3 | 0.7 | 1.1 | 2.0 |

### Adhesion Peel Testing

Adhesion peel testing was undertaken according to a modified version of ASTM C794 on test pieces of conventional architectural glass. Two of the glass test pieces utilized were coated with low emissivity (Low-E) coatings.
Low-E coating 1 was Viracon™ VE-2M which is commercially available from Viracon; and
Low-E coating 2 was Viracon™ VE-45 which is commercially available from Viracon.

The substrates (as identified in Table 2c below) were prepared by wiping twice with isopropyl alcohol (IPA) and air dried. Stainless steel screens (20×20×0.016″) (50.8×50.8×0.0406 cm), 0.5″ thick (1.27 cm) in width were prepared by cleaning with xylene and priming with DOWSIL™ 1200 OS Primer from Dow Silicones Corporation and drying for 24 hours after each step. A bead of mixed sealant was applied to the substrate and drawn down to ⅛″ (0.3175 cm) thickness. Next, the screen was lightly pressed into the sealant, and a second bead of sealant was applied onto the screen and drawn down to ¼″ (0.635 cm) total thickness. Prior to testing, a fresh score mark was created with a knife at the substrate/sealant interface just below the screen. The adhesion peel strength was measured by pulling the screen 180° at 2.0 in/min (5.08 cm per minute) using an Instron 33R 4465 with a 5 kN load cell. Data was collected and analyzed using Bluehill v. 2.8 software. Reported values are an average of three replicates.

Cohesive failure (CF) is observed when a cured material breaks without detaching from a substrate to which it is adhered. Adhesive failure (AF) refers to the situation when the cured material detaches cleanly (i.e., peels off) from a substrate. In some cases, a mixed failure mode may be observed: where there is a mixture of AF and CF. In such a situation the proportions of surface displaying CF (% CF) and AF (% AF) behavior are determined with % CF+% AF=100%.

TABLE 2c
Adhesion peel strength after 24 h

| | Low-E Coating 1 | | Low-E Coating 2 | | Glass | |
|---|---|---|---|---|---|---|
| | Peel | | Peel | | Peel | |
| | Strength | Mode | Strength | Mode | Strength | Mode |
| | (N/mm) | (% CF) | (N/mm) | (% CF) | (N/mm) | (% CF) |
| Ex. 1 | 2.21 | 100 | 2.14 | 100 | 2.15 | 100 |
| Ex. 2 | 1.42 | 100 | 1.24 | 83.3 | 1.24 | 100 |
| Ex. 3 | 1.26 | 80 | 1.80 | 100 | 1.54 | 100 |
| C. 1 | 2.82 | 100 | 3.05 | 100 | 2.68 | 100.0 |

| | | | | | |
|---|---|---|---|---|---|
| C. 2 | 3.06 | 0 | 2.00 | 0 | No data |

It can be seen in Table 2c that the inventive samples Ex. 1 to 3 are superior to C. 2 (WO2019027897) because they build adhesion to the referenced reflective coating within 24 hours. This is a surprising result because the catalyst package of both the inventive samples and C. 2 comprise a fully compatible continuous phase. However, the aminosilane used in the inventive examples is incompatible with the industry standard trimethylsiloxy-terminated polydimethylsiloxane of C. 1 which can lead to phase separation in storage of the catalyst package. It was found that, when using carrier fluid (i) herein together with the other ingredients (ii) to (iv) and optionally (v) of the catalyst package, a fully compatible, shelf stable continuous phase was generated. In particular it was found that the carrier fluid (i) and aminosilanes (iii) were miscible after initial mixing and did not separate over time. Hence, it was found that using polyethers as described herein as carrier fluid (i) in the catalyst package enabled the use of aminosilanes as described herein in the catalyst package without phase separation which is often seen after storage when the carrier fluid is the industry standard trimethylsiloxy-terminated polydimethylsiloxane. Furthermore, that it is further unexpected that, unlike the C. 1 and C. 2 comparative examples, the inventive samples utilize a carrier fluid in the catalyst package that is incompatible with the base, yet they show equivalent or superior bulk durometer build and adhesion for a given time of curing.

1. A two-part moisture curing silicone composition having a base part and catalyst package part, wherein the catalyst package part comprises:
(i) a carrier fluid which is one or more silicon-free, linear or branched polyethers comprising repeating units having the average formula (—CₙH₂ₙ—O—)_{y} wherein n is an integer from 3 to 6 inclusive and y is at least four, comprising one or more —OH terminal groups, —OR¹⁰ terminal groups or —OH and —OR¹⁰ terminal groups where R¹⁰ is an optionally functionalised hydrocarbon group having from 1 to 12 carbons;
(ii) a cross-linker of the structure R⁵ₐ—Si—R⁶₄₋ₐ wherein each R⁵ is an alkoxy group having from 1 to 10 carbons, a ketoximino group or an alkenyloxy group; each R⁶ is selected from is a non-hydrolysable silicon-bonded organic group, and a is 2, 3 or 4 or bis (trimethoxysilyl)hexane or 1,2-bis (triethoxysilyl)ethane;
(iii) an aminosilane;
(iv) a tin-based catalyst; and optionally
(v) a reinforcing filler, a non-reinforcing filler or a mixture of reinforcing filler and non-reinforcing filler.

2. The two-part moisture curing silicone composition in accordance with claim 1, wherein the base part comprises:
(a) a siloxane polymer having at least two terminal hydroxyl or hydrolysable groups and having a viscosity of from 1,000 to 200,000 mPa-s at 25° C.;
(b) one or more reinforcing fillers; and optionally
(c) one or more non-reinforcing fillers.

3. The two-part moisture curing composition in accordance with claim 1, wherein R¹⁰ of the carrier fluid (i) is an alkyl group, an aryl group, an acetyl group, an amine group, an ester group or an unsaturated hydrocarbon group.

4. The two-part moisture curing composition in accordance with claim 1, wherein repeating units having the average formula (—CₙH₂ₙ—O—)_{y} of the silicon-free, linear or branched polyether are selected from trimethylene oxide units, tetramethylene oxide units, oxypropylene units and/or oxybutylene units and/or y is at least 50.

5. The two-part moisture curing composition in accordance with claim 1, wherein the weight ratio of the base part: catalyst package part when to be mixed is between 15:1 and 1:1.

6. The two-part moisture curing composition in accordance with claim 1, wherein each R⁵ of cross-linker (ii) is selected from a dimethyl ketoximo group, an isobutylketoximino group; a methoxy, ethoxy, propoxy iso-propoxy, butoxy, t-butoxy, pentoxy, isopentoxy, hexoxy or isohexoxy group or an isopropenyloxy, or 1-ethyl-2-methylvinyloxy group.

7. The two-part moisture curing composition in accordance with claim 1, wherein the reinforcing filler (v) is present and selected from fumed silica, precipitated silicas and/or precipitated calcium carbonate.

8. The two-part moisture curing composition in accordance with claim 1, wherein the catalyst package part comprises additional non-amino adhesion promoters, adhesion catalysts, flame retardants, one or more pigments and/or colorants, rheology modifiers, antioxidants, UV and/or light stabilizers and fungicides and/or biocides.

9. The two-part moisture curing composition in accordance with claim 1, wherein the base part comprises;
10 to 90 wt. % of siloxane polymer (a);
10 to 80 wt. % reinforcing fillers (b); and
0 to 20 wt. % of non-reinforcing fillers (c);
with the total wt. % of the base part being 100 wt. %.

10. The two-part moisture curing composition in accordance with claim 1, wherein the catalyst package part comprises:
carrier fluid (i) in an amount of from 30 to 80 wt. % of the catalyst package part;
cross-linker (ii) in an amount of 0.5 to 25 wt. % of the catalyst package part;
aminosilane (iii) in an amount of from 5 to 25 wt. % of the catalyst package part;
tin-based catalyst (iv) in an amount of from 0.01 to 3 wt. % of the catalyst package part;
and optionally
a reinforcing filler, a non-reinforcing filler or a mixture of reinforcing filler and non-reinforcing filler (v) in an amount of from 0 to 50 wt. % depending on the mixing ratio of the two-parts of the composition;
with the total wt. % of the catalyst package part being 100 wt. %.

11. At least one of a coating, caulking, mold making, or encapsulating material comprising or formed from the two-part moisture curing composition in accordance with claim 1.

12. (canceled)

13. (canceled)

14. (canceled)

15. (canceled)
